(19) United States
(12) Patent Application Publication
(10) Pub. No.: US 2011/0182456 A1
(43) Pub. Date: Jul. 28, 2011

(54) Boundary Microphone

(76) Inventor: Hiroshi AKINO, Tokyo (JP)

(21) Appl. No.: 12/971,485

(22) Filed: Dec. 17, 2010

(30) Foreign Application Priority Data
Jan. 25, 2010 (JP) 2010-013018

(51) Int. Cl. H04R 11/04

(52) U.S. Cl. 381/361

(57) ABSTRACT

A boundary microphone includes a base, a microphone unit that is mounted on the base and converts sound into electrical signals, and a pressure-sensitive switch that switches on/off the output signals from the microphone unit. The pressure-sensitive switch includes a membrane covering a circuit board having an electrode pattern on its upper surface, a spacer disposed between the membrane and the circuit board. The electrode pattern is turned on the pressure-sensitive switch upon contact with the membrane. The membrane is composed of a conductive cloth having flexibility in the thickness direction.

### TECHNICAL FIELD

The present invention relates to a boundary microphone that has a pressure-sensitive switch switching output signals from a microphone unit and is primarily used on a table.

### Background Art

Boundary microphones have pressure-sensitive switches switching output signals from microphone units and are used on tables. The boundary microphones, which are primarily used on desks or floors in, for example, TV studios and conference halls, are also called surface mount microphones (on-surface sound pickup microphones). For example, as is disclosed in Japanese Unexamined Patent Application Publication No. 2008-288933, a boundary microphone is primarily used on a table; thus, a microphone unit and an accompanying circuit are incorporated into a low-profile flat casing in many cases so that its existence is unnoticed.

With reference to FIG. 5, a boundary microphone 11 includes a flat metal base 10 having an opening on the top, a microphone cover 15 that is composed of a metal plate having a large number of openings (sound inlet openings) and covers the top surface of the base 10, a pressure-sensitive switch 1, an external thread 12, a circuit board 18 of the boundary microphone 11, and a microphone unit 13. A microphone cord 16 and a cord bush 17 are disposed at the rear of the base 10 (at the left end in FIG. 5).

As shown in FIG. 5, a typical boundary microphone 11 has a switching unit of an appropriate type, such as a membrane, electrostatic capacity, or mechanical type, which allows an operator to control the on/off switching of output signals from the microphone unit, for example, in the front thereof. Use of a push switch having click feeling generates noise due to vibration of the microphone itself by the switching operation with click feeling. Accordingly, a membrane pressure-sensitive switch 1, which generates less noise in aural signals during the operation of a boundary microphone 11, is generally used for on/off switching of output signals from the boundary microphone 11.

As shown in FIG. 4, the membrane pressure-sensitive switch 1 includes a membrane 20 bendable by press by an operator, a circuit board 2 having an electrode pattern 5 to check for electrical connection, and a spacer 3 defined between the membrane 20 and the circuit board 2. Pressing the membrane 20 to be put into contact with the pattern 5 leads to switching on of the pressure-sensitive switch 1, while releasing the membrane 20 from pressing leads to switching off. A disadvantage of the membrane pressure-sensitive switch 1 is a small stroke of the thin membrane 20 when the operator presses the pressure-sensitive switch 1 by his/her finger 21; hence, the operator does not feel perceptible displacement and cannot confirm the normal operation of the pressure-sensitive switch 1. In addition, a flat traveling contact between the membrane 20 and the pattern 5 generates only small contact pressure per unit area. Accordingly, the operator feels difficulty in pressing the pressure-sensitive switch 1 and tends to apply excessive force to the pressure-sensitive switch 1 or to concentrate pressure to the pressure-sensitive switch I by a ball point pen or his nail. This may damage the pressure-sensitive switch 1 in some cases.

### Summary of Invention

An object of the present invention is to provide a boundary microphone including a pressure-sensitive switch that exhibits enhanced feeling of pressing operation by an operator, is operable with small pressing force by the operator, and does not break during the operation.

Another object of the present invention is to provide a boundary microphone including a pressure-sensitive switch having an enhanced contact pressure per unit area and thus having high reliability of operation.

A boundary microphone of the present invention includes a base; a microphone unit mounted on the base, the microphone unit converting sound into electrical signals; a pressure-sensitive switch of a membrane type switching on/off output signals from the microphone unit; the pressure-sensitive switch comprising a circuit board; a membrane covering the circuit board; an electrode pattern provided on the circuit board, the electrode pattern turning on the pressure-sensitive switch upon contact with the membrane; and a spacer disposed between the membrane and the circuit board; the membrane comprising a conductive cloth having flexibility in the thickness direction.

In the present invention, the membrane of the pressure-sensitive switch is composed of a conductive cloth having flexibility in the thickness direction. Since an operator must press this pressure-sensitive switch with his/her finger at an appropriate pressure and stroke, the operator can readily operate the pressure-sensitive switch by distinct operational feeling. Since the operator does not press the pressure-sensitive switch with strong force, the pressure-sensitive switch is not damaged. In addition, the conductive cloth comes into contact with the electrode pattern at multiple points, resulting in improved reliability of operation of the pressure-sensitive switch due to an increase in contact pressure per unit area.

### BRIEF DESCRIPTION OF DRAWINGS

FIG. 1 is a cross-sectional view of a pressure-sensitive switch of a boundary microphone in accordance with an embodiment of the present invention;

FIG. 2 is a top view of an exemplary spacer of the pressure-sensitive switch shown in FIG. 1;

FIG. 3 is a schematic view of the pressure-sensitive switch in use;

FIG. 4 is a schematic view of a conventional pressure sensitive switch in use of a boundary microphone; and

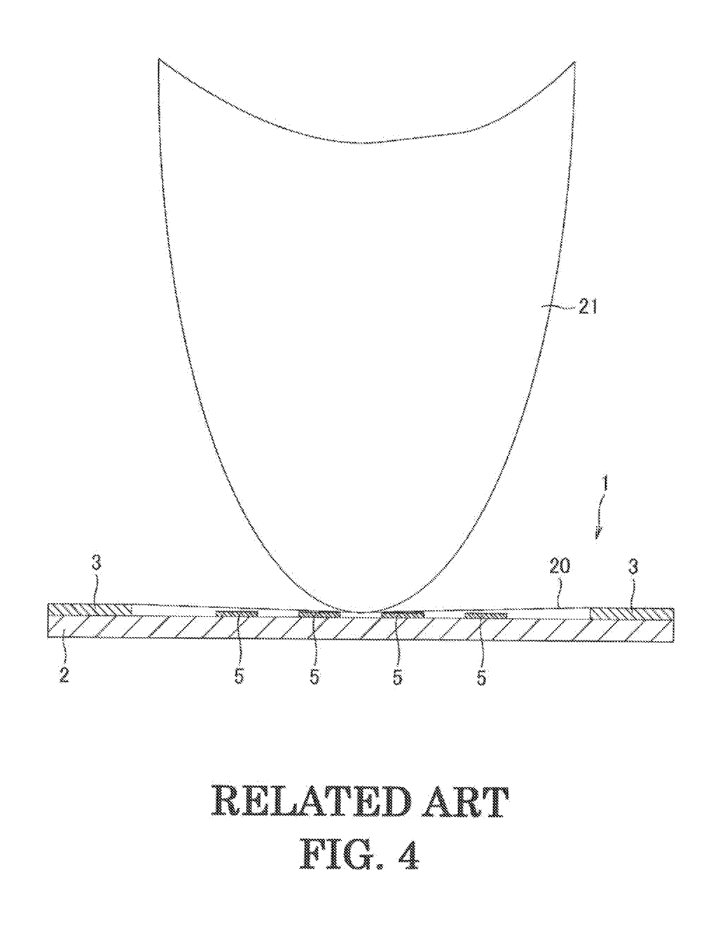

FIG. 5 is a cross-sectional view of a conventional boundary microphone.

### DESCRIPTION OF EMBODIMENTS

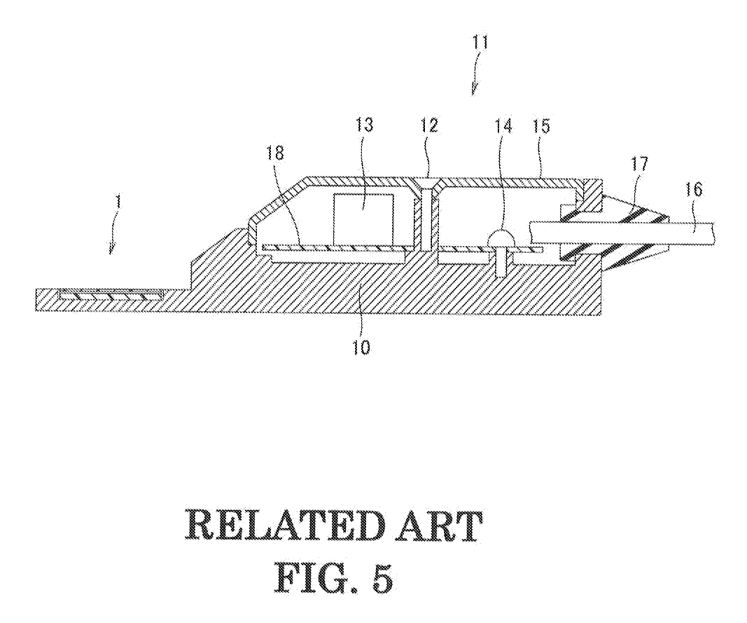

Embodiments of a boundary microphone in accordance with the present invention are described below with reference to the attached drawings. The present invention is characterized by a configuration of a pressure-sensitive switch of the boundary microphone and the configuration of the main frame of the boundary microphone can be the same as that of the conventional microphone shown in FIG. 5. Accordingly, the configuration of the main frame of the boundary microphone of the present invention is described with reference to FIG. 5.

The boundary microphone 11 primarily includes a flat metal base 10 having an opening on the top, a microphone cover 15 that is composed of a metal plate having a large number of openings (sound inlet openings) and covers the top surface of the base 10, a pressure-sensitive switch 1, an external thread 12, a circuit board 18 of the boundary microphone 11, and a microphone unit 13. A microphone cord 16 and a cord bush 17 are disposed at the rear of the base 10 (at the left end in FIG. 5). The circuit board 18 is fixed to the interior of the boundary microphone 11 by a screw 14. The pressure-sensitive switch 1. may be disposed at any appropriate position, for example, in front of the base 10 or within the main frame of the base 10 by any fixing means.

The boundary microphone 11 may have any shape and structure depending on its design concept. For example, the base 10 and the microphone cover 15 have a planar shape with, such as a substantially quadrangular shape, and the body of the boundary microphone composed of these components may also have a substantially quadrangular shape. The base 10 may have any other planar shape with, for example, a triangular shape. The base 10 is typically a zinc die-cast product. Alternatively, the base 10 may be a press-molded product of metal. The microphone cover 15 is typically composed of a punching plate (perforated plate) of iron or any other metal. Metal gauze may also be used instead of the punching plate. In the case of a boundary microphone 11, the microphone unit 13 is typically a capacitor microphone unit including an impedance converter. The printed circuit board 18 includes a tone control circuit and a voice output circuit (which are not shown in the drawing). The printed circuit board 18 is connected to an end of the microphone cord 16. The other end of the microphone cord 16 is extracted from the base 10 through the cord bush 17. In the case of a wireless microphone, the microphone case 1 has an antenna as a transmission means. An optical wireless microphone includes, for example, a light-emitting diode.

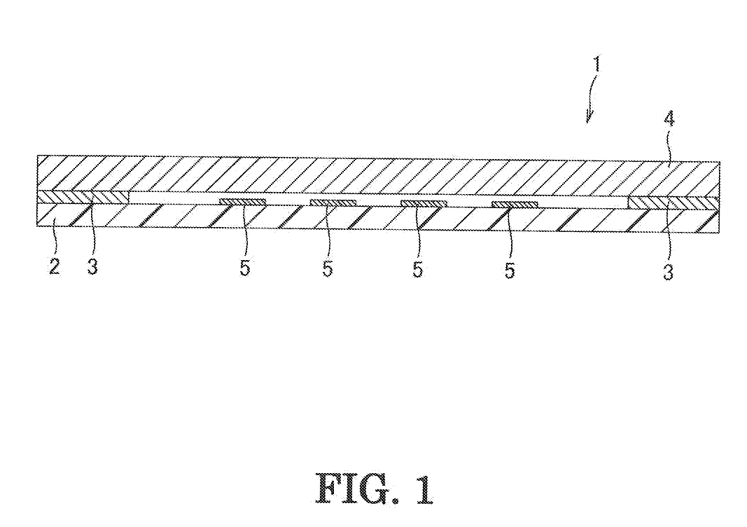

The pressure-sensitive switch, which is the element characteristic to the present invention, is described below. With reference to FIG. 1, the membrane pressure-sensitive switch 1 includes a membrane 4 that is a flexible conductive cloth deformable by press by an operator, a circuit board 2 having a pattern 5 detecting electrical connection on its top face, and a spacer 3 between the membrane 4 and the circuit board 2. The membrane 4 has a rectangular planar shape and is bonded to the spacer 3 by any means so as to cover the upper face of the circuit board 2. The spacer 3 has a rectangular circumferential frame that is bonded to the membrane 4 by any means. The circuit board 2 having a rectangular planar shape is bonded to the bottom surface of the spacer 3 by any means. When an operator presses the membrane 4, the membrane 4 comes into contact with the pattern 5 to turn on the pressure-sensitive switch 1. When the operator stops pressing the membrane 4, the membrane 4 is detached from the pattern 5 to turn off the pressure-sensitive switch 1. The membrane 4, spacer 3, and circuit board 2 may have any planar shape other than the shape described above, for example, an elliptical shape.

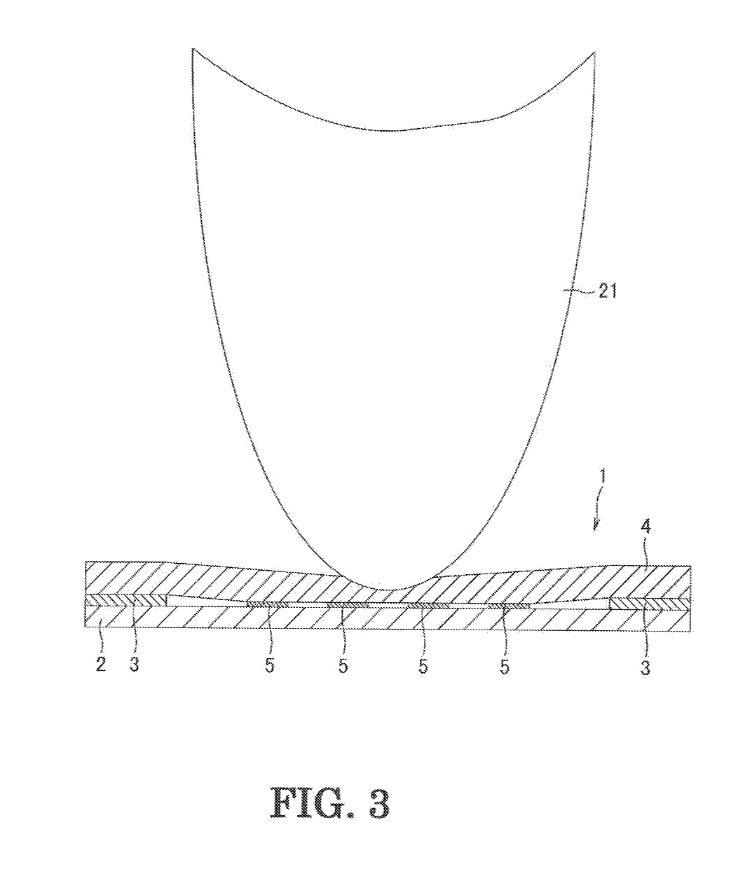

With reference to FIG. 3, the membrane 4 of the pressure-sensitive switch 1 is a conductive cloth having flexibility in the thickness direction as described above. Since the operator must press the pressure-sensitive switch 1 with his/her finger 21 at an appropriate pressure and stroke corresponding to the thickness of the conductive cloth for switching operation, the operator can readily operate the pressure-sensitive switch 1 by distinct operational feeling. Since the operator does not press the pressure-sensitive switch 1 with strong force, the pressure-sensitive switch 1 is not damaged. In addition, the conductive cloth has a large number of asperities on its surface. When the operator presses the pressure-sensitive switch 1 toward the electrode pattern 5, which is the fixed contact of the pressure-sensitive switch 1, of the circuit board 2, the conductive cloth comes into contact with the electrode pattern 5 at multiple points, resulting in improved reliability of operation of the pressure-sensitive switch 1 due to an increase in contact pressure per unit area. The upper face of the membrane 4 may be provided with a decorative sheet composed of, for example, vinyl chloride.

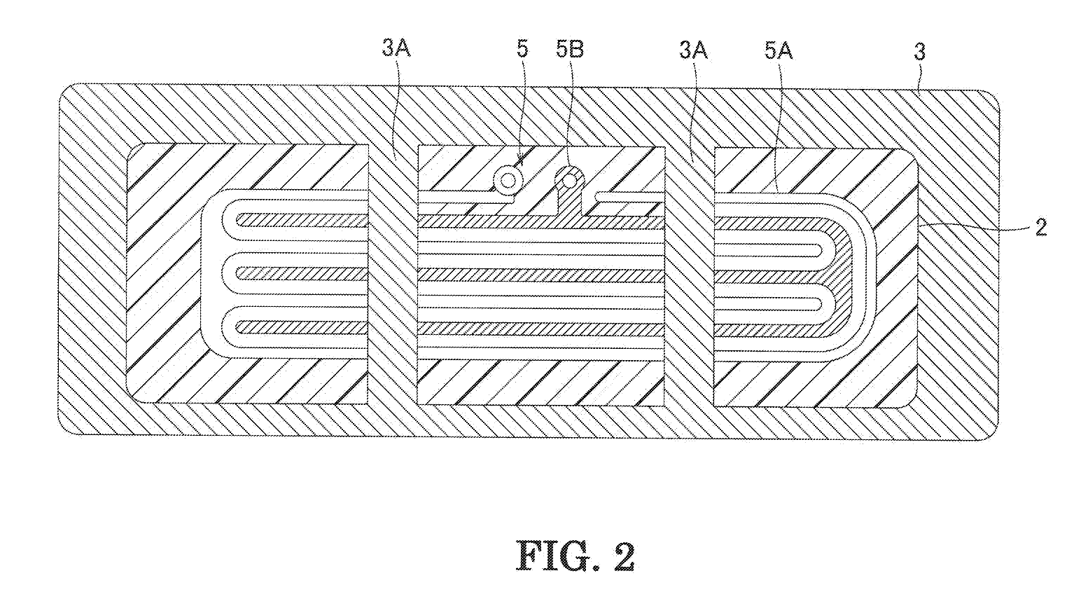

With reference to FIG. 2, the circuit board 2 of the pressure-sensitive switch 1 is disposed such that the pattern 5, which is composed of copper foil, for detection of conductivity faces the membrane 4. The circuit board 2 of the pressure-sensitive switch 1 is a flexible printed circuit board. The pattern 5 may be composed of two interdigital pattern elements, i.e., a first electrode pattern elements 5A and a second electrode pattern elements 5B (shaded portion) alternately interdigitated as shown in the drawing. When the operator presses down the membrane 4 toward the pattern 5 of the circuit board 2 of the pressure-sensitive switch 1, the membrane 4 is designed to come into contact with both the first and second electrode pattern elements 5A and 5B to switch on the pressure-sensitive switch 1 through electrical connection between these pattern elements 5A and 5B. The circuit board 2 may be composed of any appropriate material other than the flexible circuit board.

The membrane 4 and the circuit board 2 of the pressure-sensitive switch 1 are separated by the spacer 3 disposed at the peripheries thereof in order to avoid malfunction of the pressure-sensitive switch 1 by incidental contact of the membrane 4 and the circuit board 2. The spacer 3 has a shape of a grid frame 3A that defines rectangular openings and supports the membrane 4, as shown in FIG. 2. The frame 3A more surely avoids the malfunction due to contact of the membrane 4 to the electrode pattern 15 even if the membrane 4 unstrains.

The frame 3A of the spacer 3 supporting the membrane 4 may have a plurality of openings having any shape, such as a circle or triangle, instead of the grid shown in FIG. 2. Alternatively, the spacer 3 may have a circular or rectangular frame having only a single opening to be disposed at the peripheries of the pressure-sensitive switch 1. The frame 3A of the spacer 3 may be formed by any means, for example, press-punching or lithography of the spacer 3. The pressure-sensitive switch 1 may be provided with a self-holding circuit that can hold the ON state during a certain time after the operator detaches from the pressure-sensitive switch 1.

The embodiments of the present invention have been explained above. The present invention, however, should not be limited to the embodiments. For example, the switch mechanism of the boundary microphone of the present invention should not be limited to the boundary microphone, but can also be applied to a microphone provided with a speaker that is used on a table.

What is claimed is:

1. A boundary microphone, comprising:
a base;
a microphone unit mounted on the base, the microphone unit converting sound into electrical signals; and
a pressure-sensitive switch of a membrane type switching on/off output signals from the microphone unit; the pressure-sensitive switch comprising;
a circuit board;
a membrane covering the circuit board;
an electrode pattern provided on the circuit board, the electrode pattern turning on the pressure-sensitive switch upon contact with the membrane; and
a spacer disposed between the membrane and the circuit board; the membrane comprising a conductive cloth having flexibility in the thickness direction.

2. The boundary microphone according to claim 1, wherein the circuit board is a flexible printed circuit board.

3. The boundary microphone according to claim 1, wherein the spacer has a frame supporting the membrane.

4. The boundary microphone according to claim 3, wherein the spacer has a grid shape.

5. The boundary microphone according to claim 1, wherein the electrode pattern comprises two interdigital electrode pattern elements, wherein the pressure-sensitive switch is turned on upon contact of the two electrode pattern elements with the membrane.
